(19) United States
(12) Patent Application Publication
(10) Pub. No.: US 2001/0035253 A1
(43) Pub. Date: Nov. 1, 2001

(54) CERAMIC SINTERED BODY AND PRODUCTION METHOD THEREOF

(76) Inventors: KOUJI KAWAKITA, JOYO-SHI (JP); HIROSHI KAGATA, HIRAKATA-SHI (JP); MARIKO ISHIKAWA, OSAKA-SHI (JP)

Correspondence Address: WENDEROTH LIND AND PONACK LLP, SUITE 800, 2033 K STREET NW, WASHINGTON, DC, 20006

(21) Appl. No.: 09/332,905

(22) Filed: Jun. 15, 1999

(30) Foreign Application Priority Data
Jun. 16, 1998 (JP) P 10-168278
Dec. 3, 1998 (JP) P 10-344614

(51) Int. Cl. B32B 3/10

(52) U.S. Cl. 156/89.12; 428/137

(57) ABSTRACT

To provide a flat ceramic sintered body without warp and waviness, and a method of producing the same.

There is provided a flat ceramic sintered body which has been fired at a predetermined firing temperature, characterized in that resin layers on which oxide particles having a higher melting point than the firing temperature are dispersed are formed on both sides of a ceramic green body, and that the resultant laminate is fired.

### BACKGROUND OF THE INVENTION

1. Field of the invention

The present invention relates to a flat ceramic sintered body and a production method thereof.

2. Description of the Prior art

Elements that convert a stress into electric power, such as piezoelectric ceramics are demanded to be made thinner in order to increase output or sensitivity. Likewise, wiring boards such as glass ceramics are also required to be thinner in view of bodyification of output units, mounting of semiconductors and the like. Flat ceramics are usually fired on, for example, magnesia or zirconia particles which have a relatively large particle size of several tens μm so as to prevent fusion between a specimen and a sagger in process of sintering.

However, there are difficulties in obtaining a ceramic sintered body having a few warp and waviness, because firing a thin flat ceramics is accompanied by problems in that there occur in the ceramics relatively large waviness depending on the particle size of magnesia or zirconia particles and warps caused by the fusion with plates for firing. It is particularly difficult to obtain a ceramic sintered body which has a laminate structure having an electrode formed 500 μm or less.

Also it is difficult to obtain a ceramic sintered body having through holes and having a few warp and waviness.

### SUMMARY OF THE INVENTION

An object of the present invention is therefore to provide a flat ceramic sintered body without warp and waviness and a production method thereof.

In order to achieve the above object, the present invention is constituted as follows.

A ceramic sintered body according to the present invention is a flat ceramic sintered body which is fired at a predetermined firing temperature, and oxide particles having a higher melting point than the above firing temperature are dispersed on and adhered to at least one side of the ceramic sintered body.

Thus constituted, the flat ceramic sintered body can have good flatness without warp or waviness since the fusion with a plate for firing is prevented in process of firing.

In the present invention, the ceramic sintered body may be a laminate having an inner electrode layer therein, and a laminate ceramic sintered body with good flatness can be provided.

Also, a similar effect is provided when the above ceramic sintered body has a surface electrode layer formed on the main side thereof. In this case, it is preferable to disperse and adhere the above oxide particles to the surface electrode layer so as to prevent the fusion between the surface electrode layer and the plate for firing.

Also, a similar effect is provided when the above ceramic sintered body comprises through holes. In this case, it is preferable that the volume occupied by said through holes is within 20 of the total volume of the ceramic sintered body.

Further, the thickness of the above ceramic sintered body of the present invention may be 500 μm or less, and particularly, the present invention is effectively applied to a flat ceramic sintered body with a thickness of 500 μm or less, which hitherto has been difficult to be produced, without causing warp and waviness therein.

Also, in the present invention, the ceramic sintered body may be formed from a lead-based piezoelectric material, and it is very advantageous to apply the present invention particularly to a piezoelectric ceramic sintered body which recently has been demanded to be made thinner.

In the present invention, the above oxide particles are preferably those of one, or two or more selected from the group consisting of magnesia (MgO), zirconia (ZrO) and alumina (Al₂O₃), and the use of the above oxide particles is effective to prevent the fusion with the plates for firing in process of firing, so that the ceramic sintered body can have higher flatness.

It is preferable for the above oxide particles to have a particle size of 2 μm or less, and thus restricted in particle size, a ceramic sintered body with further higher flatness can be provided.

On the other hand, in the first production method of the ceramic sintered body according to the present invention, a flat ceramic green body is fired at a predetermined temperature to provide a ceramic sintered body, and the method comprises the steps of

dispersing in a resin oxide particles having a higher melting point than the above firing temperature to be formed into a sheet thinner than the above ceramic green body, thereby making an oxide green sheet,

laminating the oxide green sheet on the main side of the ceramic green body to make a green laminate in which an oxide particle-dispersed resin layer consisting of the above oxide green sheet is formed on at least one of the main sides of the ceramic green body,

placing the green laminate between each of plates for firing stacked at predetermined intervals, facing to each other, and

firing the green laminate at the above firing temperature.

By making the ceramic sintered body by the above method, the fusion with the plates for firing can be prevented by the oxide particles dispersed in the oxide particle-dispersed resin layer, so that the ceramic sintered body can have high flatness without warp or waviness.

In addition, the first production method of the ceramic sintered body according to the present invention includes making of a green multi-ply which is prepared by laminating a plurality of the above green laminates. In this regards, it is preferable to fire the above green multi-ply at the above predetermined temperature in the above firing step, so as to make a sintered multi-ply and then to divide the sintered multi-ply at the oxide particle layers into individual ceramic sintered bodies. By doing so, more ceramic sintered bodies can be fired at once, so that the productivity is improved.

Also, a similar effect is provided when the above method of producing a ceramic sintered body comprises the step of making the through holes in said green laminate between said laminating step and said firing step.

In the second production method of the ceramic sintered body according to the present invention, a flat ceramic green body is fired at a predetermined temperature to form a ceramic sintered body, and the method comprises the steps of making a green laminate which has an oxide particle-dispersed resin layer laminated on at least one of the main sides of the ceramic green body, by printing with a paste which is prepared by dispersing in a resin oxide particles having a melting point higher than the above firing temperature,

placing the green laminate between each of plates for firing stacked at predetermined intervals, facing to each other, and

firing the green laminate at the above predetermined firing temperature.

When the ceramic sintered body is produced by the above method, the fusion with the plates for firing can be prevented by the oxide particles dispersed in the oxide particle-dispersed resin layer. Thus, the ceramic sintered body can have high flatness without warp or waviness.

Also, a similar effect is provided when the above method of producing a ceramic sintered body comprises the step of making the through holes in said green laminate between said laminating step and said firing step.

The second production method of the ceramic sintered body according to the present invention includes making of a green multi-ply which is prepared by laminating a plurality of the green laminates. In this regard, it is preferable to make a sintered multi-ply by firing the green multi-ply at the above predetermined temperature in the firing step and to divide the sintered multi-ply at the oxide particle layers into individual ceramic sintered bodies. By doing so, more ceramic sintered bodies can be fired at once, so that the productivity is improved.

In the first and second production methods of the ceramic sintered bodies according to the present invention, it is preferable for the thickness of the above oxide particle-dispersed resin layers to be 0.5 to 5 μμm.

The first and second production methods of the ceramic sintered bodies according to the present invention may include a step of making the above ceramic green body by laminating ceramic green sheets.

In this case, a step of forming an electrode on the ceramic green sheet also may be included, so that the ceramic green body can have the electrode layer therein.

In the step of making the above ceramic green body, an electrode layer may be formed on the uppermost layer of the ceramic green body, and the oxide particle-dispersed resin layer may be formed on the electrode layer.

In the first and second production methods of the ceramic sintered bodies according to the present invention, the ceramic green body may contain a lead-based piezoelectric material as a main component. In this sense, it is very advantageous to apply the present invention particularly to the production of piezoelectric ceramic sintered bodies which recently have been demanded to be made thinner.

In the first and second production methods of the ceramic sintered bodies according to the present invention, it is preferable for the particle size of the above oxide particles to be 2 μm or less. By decreasing the particle size, the ceramic sintered body can have still higher flatness.

In the first and second production methods of the ceramic sintered bodies according to the present invention, preferably, the oxide particles are those of one, or two or more selected from the group cosisting of magnesia (MgO), zirconia (ZrO₂) and alumina (Al₂O₃). By the use of such oxide particles, the fusion with the plates for firing can be effectively prevented in process of firing, so that the ceramic sintered body can have further higher flatness.

In the first and second production methods of ceramic sintered bodies according to the present invention, it is preferable for the thickness of the above oxide particle-dispersed resin layers to be 5 μm or lower. By doing so, the fusion with the plate for firing can be prevented in the firing step, and it becomes possible to give substantially no adverse influence on the properties of the resultant ceramic sintered body.

In the first and second production methods of the ceramic sintered bodies according to the present invention, the ceramic green body may be formed so that the resultant ceramic sintered body can have a thickness of 500 μm or lower. By doing so, the ceramic sintered body with a thickness of 500 μm or lower, which have had difficulties in diminishing warps or waviness, can be made with higher flatness.

The ceramic sintered bodies according to the present invention are made by firing the ceramic green bodies on which the oxide particle-dispersed resin layers are formed, at a predetermined firing temperature. Therefore, the fusion with the plates for firing in process of firing can be prevented, so that flat ceramic sintered bodies without warp and waviness, having high flatness and high productivity, are provided, and also the production methods thereof are provided.

### BRIEF DESCRIPTION OF THE DRAWINGS

FIG. 1 is a sectional view of a green laminate according to the embodiment 1 of the present invention, illustrating the green laminate before a firing process.

FIG. 2 is a sectional view of a ceramic sintered body of the embodiment 1.

FIG. 3A is a schematic side view of plates for firing and green laminates interposed between the plates for firing before a firing process in the embodiment 1.

FIG. 3B is a schematic side view of the plates for firing and the ceramic sintered bodies interposed between the plates for firing after the firing process in the embodiment 1.

FIG. 4A is a schematic diagram illustrating a ceramic sintered body which is fired between plates for firing stacked at a narrow interval.

FIG. 4B is a schematic diagram illustrating a ceramic sintered body which is fired between plates for firing stacked at an interval suitably adjusted.

FIG. 4C is a schematic diagram illustrating a ceramic sintered body which is fired between plates for firing stacked at a large interval.

FIG. 5 is a schematic side view of a green multi-ply.

FIG. 6 is a side view of a green multi-ply which is placed on a plate for firing so as to be fired.

FIG. 7A is a schematic side view of the plates for firing and the green laminates which are placed between the plates for firing before the firing process in the embodiment 1.

FIG. 7B is a schematic side view of the plates for firing and the ceramic sintered bodies which are placed between the plates for firing after the firing process in the embodiment 1.

FIG. 8 is a sectional view of a green laminate according to the embodiment 2 of the present invention before a firing process.

FIG. 9 is a sectional view of a green laminate according to the embodiment 3 of the present invention before a firing process.

FIG. 10 is a sectional view of a green laminate according to the embodiment 4 of the present invention before a firing process.

FIG. 11 is a perspective view of a green laminate according to the modification 1 of the present invention before a firing process.

FIG. 12 is a sectional view of a green laminate according to the modification 1 of the present invention before a firing process.

FIG. 13 is a sectional view of a green laminate according to the modification 2 of the present invention before a firing process.

FIG. 14 is a sectional view of a green laminate according to the modification 3 of the present invention before a firing process.

FIG. 15 is a sectional view of a green laminate according to the modification 4 of the present invention before a firing process.

### DETAILED DESCRIPTION

Hereinafter, the embodiments of the present invention will be described with reference to the accompanying drawings.

### EMBODIMENT

### Embodiment 1

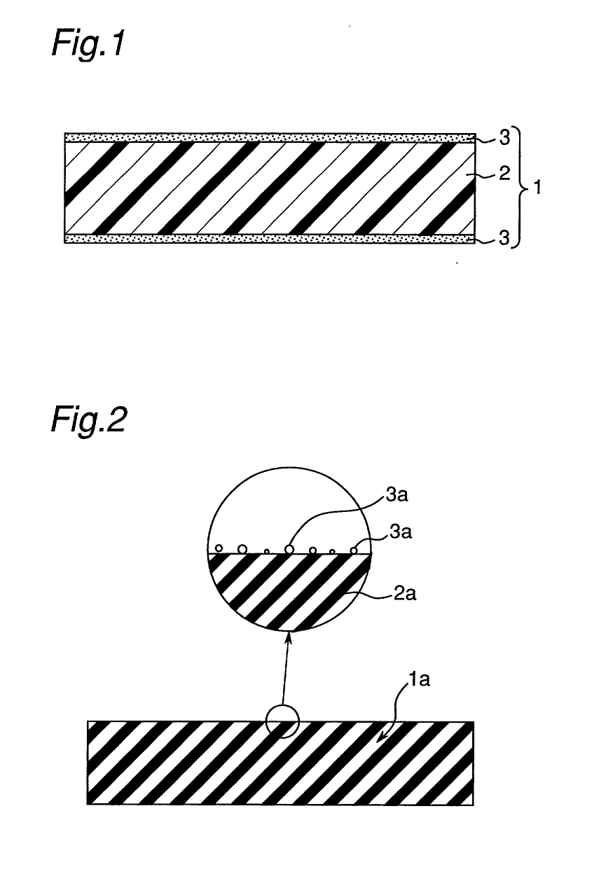

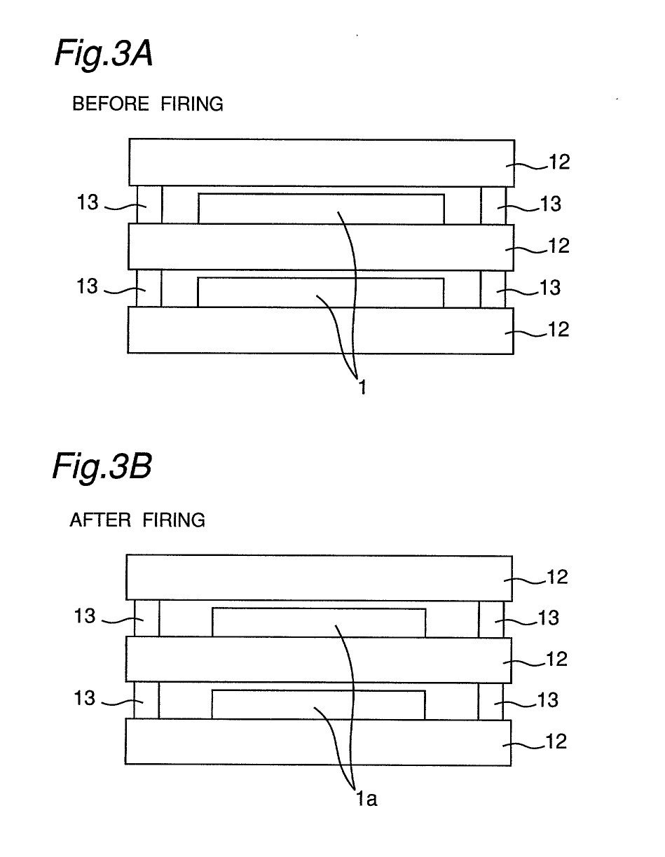

A ceramic sintered body of the embodiment 1 of the present invention is provided by firing the green laminate (1) shown in FIG. 1. In particular, the green laminate (1) shown in FIG. 1 comprises, for example, a ceramic green body (2) containing a lead-based piezoelectric ceramic powder, and oxide particle-dispersed resin layers (3) which are formed on both sides of the ceramic green body (2). As shown in FIG. 3A, the green laminates (1) are placed between each of plates for firing (12) which are stacked with spacers (13) for gap adjustment therebetween, and fired at a predetermined firing temperature.

The oxide particle-dispersed resin layer (3) is formed by dispersing in a resin oxide particles having a melting point higher than the above firing temperature, so that their particle density can be sufficiently rough as compared with that of the ceramic green body (2). In the oxide particle-dispersed resin layer (3), it is preferable for the oxide particles to be so uniformly dispersed as to be distant from one another so that the oxide particles are not sintered with one another at the above firing temperature. The fusion between the ceramic green body (2) and the plates for firing (12) can be prevented by the oxide particles which are substantially uniformly dispersed, so that it becomes possible to make a ceramic sintered body (1a) with high flatness. As shown in FIG. 2, the oxide particles (3a) are dispersed on and adhered to the surface of the ceramic sintered body (1a) which has been fired, at such distances that do not permit the oxide particles (3a) to give adverse influence on the properties of the piezoelectric ceramic sintered body (2a).

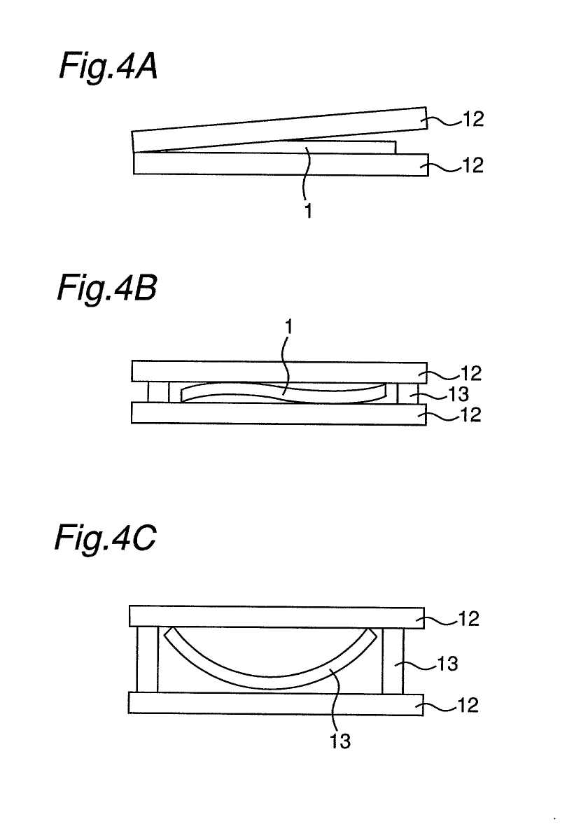

In this regard, the plates for firing (12) are formed, for example, from magnesia, and it is preferable to form the spacers (13) from the same material as that for the ceramic green body (2). In this embodiment 1, the material for the spacers (13) is the same as that for the ceramic green body (2). It is preferable that the thickness of the spacers (13) (2). It is preferable that the thickness of the spacers (13) is so determined as to be 0.05 to 0.2 mm higher than that of the green laminates (1), and that a gap of 0.05 to 0.2 mm or so is ensured between the green laminate (1) and the plate for firing (12). By doing so, deformation or warp which will occur in the green laminate (1) in process of firing can be effectively prevented as shown in FIG. 4B. For example, when the green laminates (1) are placed on the plates for firing (12) alternately without any spacer (13) between the saggers and fired, the green laminates (1) are deformed due to the weights of the plates for firing (12) as shown in FIG. 4A, so that ceramic sintered bodies with high quality can not be obtained. Also, when the gap is too small (0.05 mm or less), the fusion with the plates for firing (12) occurs because of the deformation or warps of the green laminates (1) which has occurred in process of firing, so that high quality ceramic sintered bodies can not be obtained. On the other hand, when the gap is 0.2 mm or more, the deformation or warp of the green laminate (1) can not be effectively prevented as shown in FIG. 4C. Although FIG. 4B exaggerately shows the deformation or warp in the green laminate (1), such deformation or warp is actually too small to be shown in the figure: for example, deformation or warp so small as 0.2 mm or less occurs in a green laminate having 10 cm square.

The ceramic sintered body (1a) of the embodiment 1 thus made can have high flatness because the oxide particles contained in the oxide particle-dispersed resin layer (3) prevent the fusion between the ceramic sintered body (1a) and the plate for firing (12) in process of firing, thereby preventing the warp or waviness of the ceramic sintered body (1a).

Further, by taking the form of the oxide particle-dispersed resin layer (3), the oxide particles with a relatively small particle size can be uniformly dispersed over the surface of the ceramic green body (2), so that the warp or waviness of the sinter can be decreased to improve the flatness thereof.

The spacers (13) of this embodiment 1 are formed from the same material as that for the ceramic green body (2), and therefore, the gaps between the green laminate (1) and the upper plates for firing (12) can be kept within an optimal range in process of firing so as to maintain good flatness of the sinters and to make it possible to easily separate the ceramic sintered bodies (1a) from the plates for firing (12) after the firing.

### Improved Firing Method 1 of Embodiment 1

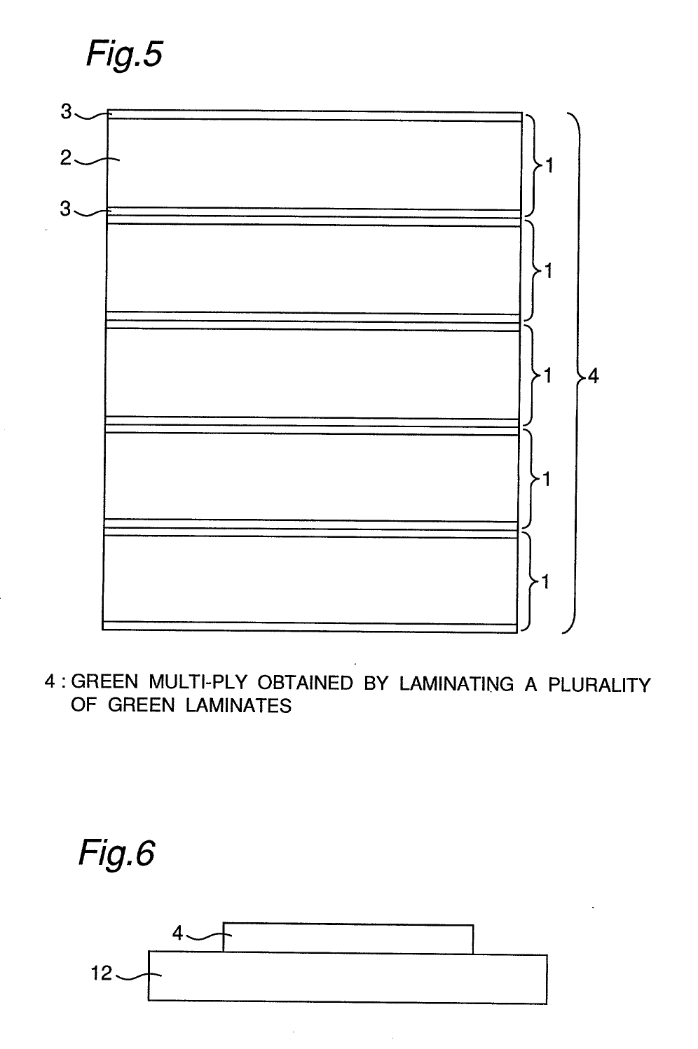

In an improved firing method for the ceramic sintered body of the embodiment 1 according to the present invention, a plurality of the green laminates (1) shown in FIG. 1 are laminated as shown in FIG. 5 so as to form a green multi-ply, and then, the green multi-ply is fired.

As shown in FIG. 6, the green multi-ply consisting of fired at a predetermined temperature on the plate for firing (12) formed from, for example, magnesia.

When the green multi-ply is fired as above, the fusion between the plate for firing (12) and the lowermost ceramic green body (2) in contact with the plate for firing (12) can be prevented by the oxide particles which are dispersed in the oxide particle-dispersed resin layer (3), and the fusion between each of the ceramic green bodies (2) adjacent to one another also can be prevented by the oxide particles which are dispersed in the oxide particle-dispersed resin layers (3).

Accordingly, in the sintered multi-ply (4a) obtained by firing the green multi-ply, the plurality of the ceramic sintered bodies (1a) in which each of the ceramic green bodies (2) is fired are laminated while being separated by the oxide particles.

As the method of dividing the sintered multi-ply (4a) into individual ceramic sintered bodies (1a), the ceramic sintered bodies (1a) which are not firmly bound to one another because of the presence of the oxide particles can be easily separated from the adjacent ceramic sintered bodies (1a), for example, by applying thermal shocks or by vibrating with supersonic waves or the like in a solution.

As described above, many ceramic laminates (1) can be efficiently fired at once, and also, ceramic sintered bodies (1a) with high flatness (see FIG. 2) can be provided.

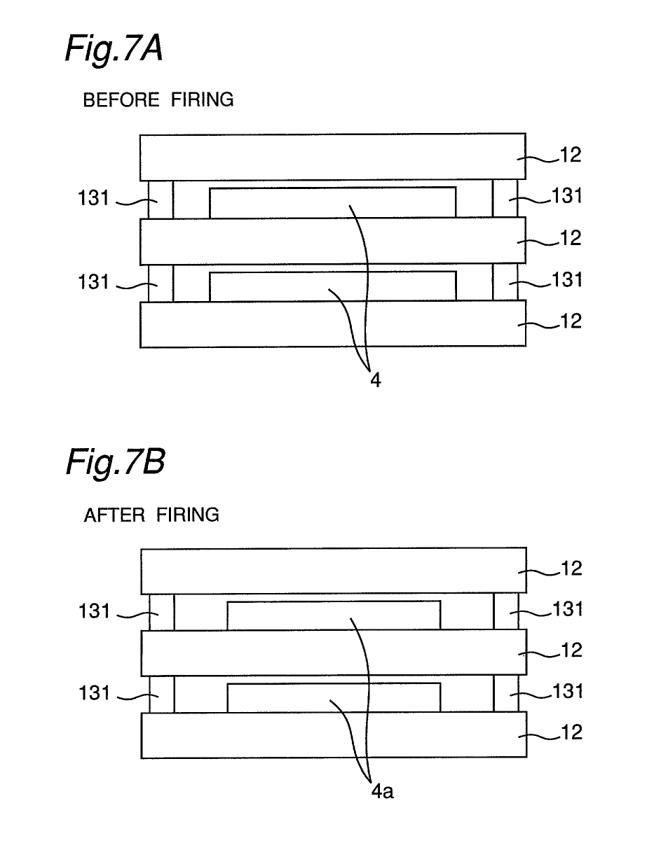

In this firing method as shown in FIG. 7A, the green multi-ply (4) consisting of the lamination of the plurality of the green laminates (1) may be placed between the plates for firing (12) which are stacked with the gap-adjusting spacers (131) interposed therebetween, and fired at the predetermined firing temperature.

In the above method wherein each of the green multi-plys (4) is placed between the plates for firing (12) facing to one another and stacked at given intervals, and fired, the warp or waviness of the ceramic sintered bodies (1a) can be further decreased by determining the thickness or the like of the spacers (131) as follows.

That is, it is preferable for the spacers (131) to be formed from the same material as that for the ceramic green bodies (2), and this firing method uses the same material for the spacers (131) as that of the ceramic green bodies (2).

Preferably, the thickness of the spacers (131) are so determined as to be 0.05 to 0.2 mm higher than that of the green multi-plys (4), and also preferably, a gap of 0.05 to 0.2 mm or so is ensured between the green multi-ply (4) and the upper plate for firing (12).

By arranging as above, the deformation or warp in the green multi-ply can be effectively prevented in process of firing for the same reasons for the case of firing a single green laminate (1) (the reasons described in connection with FIG. 4).

The above embodiment 1 has been described as using the lead-based piezoelectric ceramics for the sinter, and the lead-based piezoelectric ceramics may contain a zinc zirconate as a main component, or may contain a zinc zirconate and a zinc lanthanumate as main components.

Further, the present invention can be applied to the production of not only the lead-based piezoelectric ceramics but also other ceramic sintered bodies formed from alumina or other raw material. For example, when magnesia (m.p. 2800° C.) is used as the oxide particles, it becomes possible to fire a ceramic sintered body formed from alumina or the like of which the firing temperature is comparatively high.

That is, in the present invention, a ceramic green body containing a desired ceramic raw material powder can be used in combination with the particles of an oxide whose melting point is higher than the firing temperature of the ceramic green body.

The present invention has no restriction in the thickness of a ceramic sintered body. However, the present invention is more effectively applied to the production of a ceramic sintered body with a thickness of particularly 500 μm or less, and makes it possible to fire a laminate without causing warp.

Also, the present invention has no restriction in the thickness of the oxide particle-dispersed resin layer. However, when the thickness of the oxide particle-dispersed resin layer is 0.5 μm or more, the fusion with the plate for firing (12) can be prevented, so that the resultant ceramic sintered body can have high flatness. Also, it is preferable that the thickness of the oxide particle-dispersed resin layer is 5 μm or less. When the thickness is within this range, the oxide particles adhered to the surface of the ceramic sintered body give substantially no adverse influence on the properties of the ceramic sintered body.

Furthermore, in the embodiment 1, it is preferable that the particle size of the oxide particles dispersed in the oxide particle-dispersed resin layer is 2 μm or less, and by using such oxide particles, the flatness of the sinter can be more improved.

As described above, the ceramic sintered body of the embodiment 1 can be fired without the fusion between the specimen and the plate for firing, having no warp in process of firing because the ceramic green body is coated with the oxide particle-dispersed resin layers and then fired. Thus, ceramics with high productivity can be provided at a higher yield.

### Embodiment 2

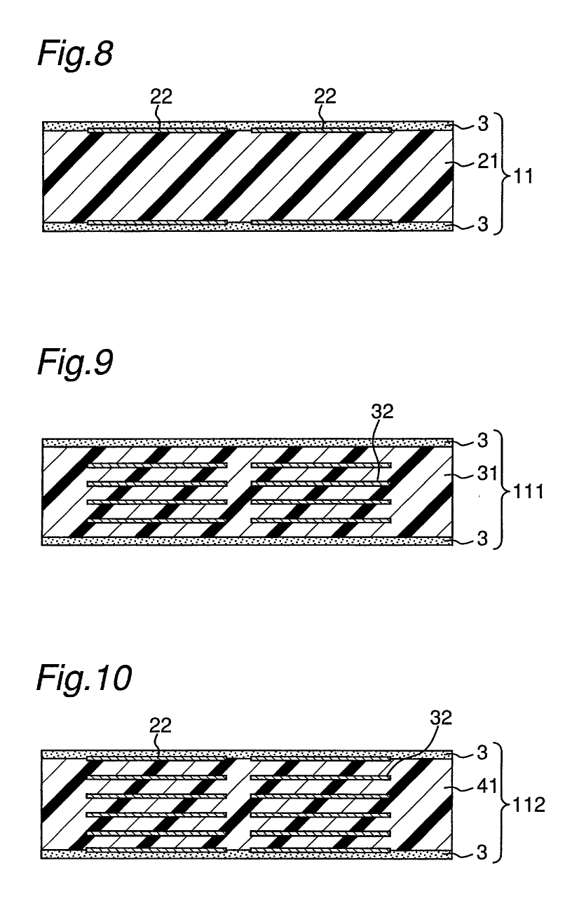

FIG. 8 is a sectional view of a green laminate (11) for a lead-based piezoelectric ceramic sintered body of the embodiment 2 according to the present invention, illustrating the green laminate (11) before a firing process. The green laminate (11) is made in the same manner as in the embodiment 1, except that surface electrode layers (22) are formed on both sides of a ceramic green body (21) as shown in FIG. 8.

As materials for the surface electrode layers (22) of the embodiment 2, silver palladium, gold, chrome, nickel, silver, palladium, copper and their alloys can be used, and other than those materials, ones that can be fired with ceramics at the same time can be used.

The green laminate (11) of the embodiment 2 can be fired in the same manner as in the embodiment 1.

The green laminate (11) of the embodiment 2 thus made can be prevented from fusing with a magnesia plate for firing in process of firing by oxide particle-dispersed resin layers (3), and thus provides the same effect as the embodiment 1.

The embodiment 2 is described as providing a lead-based piezoelectric ceramic sintered body, however, the present invention is not limited to this, and, needless to say, it can be applied to the production of ceramic sintered bodies formed from other ceramic materials. In such a case, suitable electrode materials are selected in accordance with the ceramic materials to be used.

### Embodiment 3

FIG. 9 is a sectional view of a green laminate (12) for a lead-based piezoelectric ceramic sintered body of the embodiment 3 according to the present invention, illustrating the green laminate (12) before a firing process. The green laminate (12) is made in the same manner as in the embodiment 1, except that, as shown in FIG. 9, a ceramic green body (31) containing inner electrode layers (32) is used instead of the ceramic green body (2) of the embodiment 1. The ceramic green body (31) is made as follows: for example, the inner electrode layers are formed on a ceramic green sheet containing a lead-based piezoelectric ceramic powder, and a plurality of such ceramic green sheets are laminated to make the above ceramic green body (31).

In the embodiment 3, various metals such as silver palladium, gold, chrome, nickel, silver, palladium, copper and their alloys can be used to form the inner electrode layers (32). That is, those that can be fired with ceramics at the same time can be used for the inner electrode layers.

The green laminate (12) of the embodiment 3 can be fired in the same manner as in the embodiment 1.

The green laminate (12) of the embodiment 3 thus made can be prevented from fusing with a magnesia plate for firing in process of firing by the oxide particle-dispersed resin layers (3), and thus provides the same effect as the embodiments 1 and 2.

The embodiment 3 has been described as providing a lead-based piezoelectric ceramic sintered body, however, the present invention is not limited to this, and, needless to say, it can be applied to the production of ceramic sintered bodies formed from other ceramic materials. In such a case, suitable electrode materials are selected in accordance with the ceramic materials to be used.

### Embodiment 4

FIG. 10 is a sectional view of a green laminate (13)? for a lead-based piezoelectric ceramic sintered body of the embodiment 4 according to the present invention, illustrating the green laminate (13) before a firing process. The green laminate (13) is made in the same manner as in the embodiment 1, except that a ceramic green body (41) having inner electrode layers (32) and surface electrode layers (22) as shown in FIG. 10 is used instead of the ceramic green body (2) of the embodiment 1. The ceramic green body (41) is formed as follows: for example, the inner electrode layers are formed on a ceramic green sheet containing a lead-based piezoelectric ceramic powder; a plurality of such ceramic green sheets are laminated; and the surface electrode layers are formed on the laminate to make the above ceramic green body (41).

In the embodiment 4, various metals such as silver palladium, gold, chrome, nickel, silver, palladium, copper and their alloys can be used for the inner electrode layers (32) and the surface electrode layers (22). That is, those that can be fired with ceramics at the same time can be used for the inner electrode layers and the surface electrode layers.

The green laminate (13) of the embodiment 4 can be fired in the same manner as in the embodiment 1.

The green laminate (13) of the embodiment 4 thus made can be prevented from fusing with a magnesia plate for firing in process of firing by the oxide particle-dispersed resin layers (3), and thus provides the same effect as in the embodiments 1, 2 and 3.

The embodiment 4 has been described as providing a lead-based piezoelectric ceramic sintered body, however, the present invention is not limited to this, and, needless to say, it can be applied to the production of ceramic sintered bodies formed from other ceramic materials. In such a case, suitable electrode materials are selected in accordance with the ceramic materials to be used.

### Modification

In the present invention, a similar effect is provided when the method of producing a ceramic sintered body according to embodiment 1 to 4 comprises the step of making the through holes in the green laminate.

### Modification 1

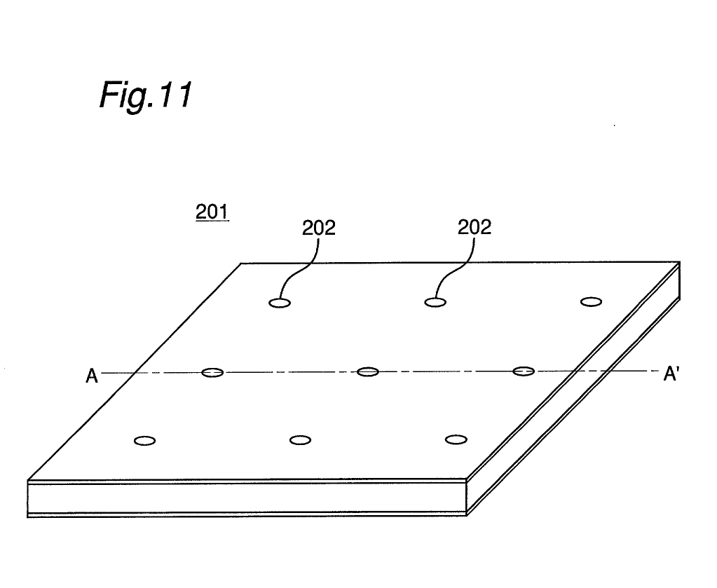

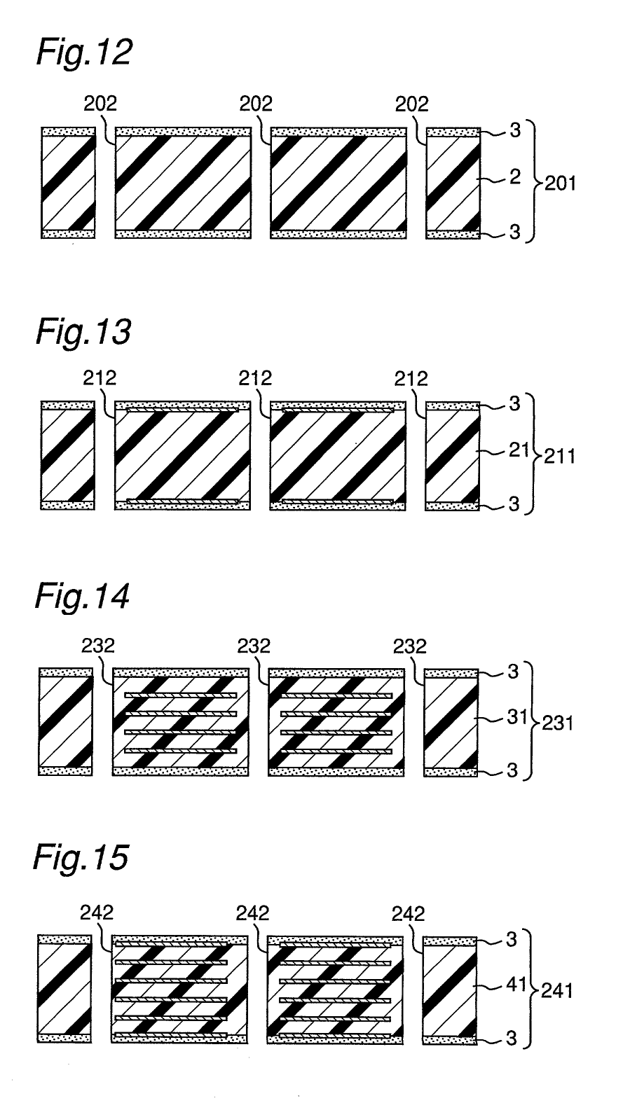

In the modification 1, the ceramic sintered body is made in the same manner as in the embodiment 1, except that, as shown in FIG. 11, a green laminate (201) having the through holes (202) is used instead of the green laminate (1) of the embodiment 1. FIG. 12 is a sectional view taken substantially along the line A-A′ of FIG. 11. Referring in the drawing, wherein like reference characters designate like or corresponding parts in the FIG. 1.

The ceramic sintered body of the modification 1 thus made can have high flatness because the oxide particles contained in the oxide particle-dispersed resin layer (3) prevent the fusion between the ceramic sintered body and the plate for firing in process of firing, thereby preventing the warp or waviness of the ceramic sintered body.

In this case, it is preferable that the volume occupied by said through holes (202) is within 20 of the total volume of the ceramic sintered body.

### Modification 2

In the modification 2, the ceramic sintered body is made in the same manner as in the embodiment 2, except that, as shown in FIG. 13, a green laminate (211) having the through holes (212) is used instead of the green laminate (11) of the embodiment 2. Referring in the drawing, wherein like reference characters designate like or corresponding parts in the FIG. 8.

The ceramic sintered body of the modification 2 thus made can have high flatness because the oxide particles contained in the oxide particle-dispersed resin layer (3) prevent the fusion between the ceramic sintered body and the plate for firing in process of firing, thereby preventing the warp or waviness of the ceramic sintered body.

In this case, it is preferable that the volume occupied by said through holes (212) is within 20 of the total volume of the ceramic sintered body.

### Modification 3

In the modification 3, the ceramic sintered body is made in the same manner as in the embodiment 3, except that, as shown in FIG. 14, a green laminate (231) having the through holes (232) is used instead of the green laminate (111) of the embodiment 3. Referring in the drawing, wherein like reference characters designate like or corresponding parts in the FIG. 9.

The ceramic sintered body of the modification 3 thus made can have high flatness because the oxide particles contained in the oxide particle-dispersed resin layer (3) prevent the fusion between the ceramic sintered body and the plate for firing (12) in process of firing, thereby preventing the warp or waviness of the ceramic sintered body.

In this case, it is preferable that the volume occupied by said through holes (232) is within 20 of the total volume of the ceramic sintered body.

### Modification 4

In the modification 4, the ceramic sintered body is made in the same manner as in the embodiment 4, except that, as shown in FIG. 15, a green laminate (241) having the through holes (242) is used instead of the green laminate (1) of the embodiment 4.

The ceramic sintered body of the modification 4 thus made can have high flatness because the oxide particles contained in the oxide particle-dispersed resin layer (3) prevent the fusion between the ceramic sintered body and the plate for firing in process of firing, thereby preventing the warp or waviness of the ceramic sintered body.

In this case, it is preferable that the volume occupied by said through holes (242) is within 20 of the total volume of the ceramic sintered body.

### EXAMPLES

Hereinafter, Examples of the present invention will be described.

### Example 1

A piezoelectric ceramic sintered body of Example 1 of the present invention was formed as follows.

First, the particles of oxides, PbO, MgO, Nb₂O₅, TiO₂ and ZrO₂ were weighed so that their stoichiometric ratio could be 1:0.042:0.042:0.435:0.440.

Next, the weighed particles were poured into a poly-pot together with zirconia grinding balls, and they were ground and mixed for 17 hours, and dried.

Then, the ground particle mixture was calcined at 1,000° C. for 2 hours to obtain piezoelectric particles (the calcined particles). The calcined particles were poured into a poly-pot together with zirconia grinding balls, and they were ground for 12 hours and dried.

Next, to form a green sheet, the ground particles, an acrylic resin, a plasticizer and butyl acetate were blended at a ratio of 1:0.06:0.03:0.5, and mixed for 48 hours. After that, the resultant mixture was formed into a piezoelectric green sheet with a thickness of 50 μm by the use of a doctor blade.

The piezoelectric green sheet was cut into 10 cm square sheet pieces, and a predetermined number of the 10 cm square sheet pieces were laminated and pressed under a pressure of 200 kg/cm² so as to form a multi-layer piezoelectric green body with a thickness of 0.1 to 2.5 mm.

To form an oxide particle-dispersed resin layer, MgO, an acrylic resin, a plasticizer and butyl acetate were blended at a ratio of 10:6:0.02:4 and mixed for 48 hours. The resultant mixture was formed into an oxide green sheet which contained magnesia and had a thickness of 5 μm by the use of a doctor blade. In this regard, as is understood from the above blending ratio, the oxide green sheet contained more resin component than the piezoelectric green sheet so that the sintering between each of the oxide particles was prevented in process of firing. In Example 1, MgO particles were used as the oxide particles.

Next, the oxide green sheets were laminated on both sides of the piezoelectric ceramic green body under a pressure of 200 kg/cm² to form a green laminate.

The green laminate was de-bound at 400° C. for 2 hours. Then, the green laminate was placed between each of the plates for firing which were formed from magnesia and stacked at given intervals as described in the part of the embodiments. The green laminate was fired at 1,100° C. for 2 hours. In this regard, the spacers for the plates for firing were made in the same manner as in the above green laminates. The spacers were made with a thickness 0.05 to 0.2 mm higher that that of the green laminate. The spacers were disposed at the four corners to form gaps between each of the plates for firing. By doing so, there could be ensured a gap of 0.05 to 0.2 mm between the green laminate and the upper plate for firing.

Lamination-layer piezoelectric ceramic green bodies with various thickness of from 0.1 to 2.5 mm were made by the above procedure, and the oxide green sheets (the oxide particle-dispersed resin layers) were laminated on each of the lamination-layer piezoelectric ceramic green bodies and each of the resultant green laminates was fired. As a result, it was found that any of the ceramic sintered bodies with the above various thickness was not fused with the magnesia plate, and that any of the ceramic sintered bodies was fired having a warp within the range of the predetermined gap (the gap between the green laminate and the upper plate for firing). Thus, the ceramic sintered bodies having few warp and high flatness could be provided.

In addition, since the oxide particles with a particle size of 2 μm or less were used, the resultant ceramic sintered body had a flat surface, and it was particularly excellent.

In this Example, the piezoelectric ceramic green body was contracted by about 20% after the firing, as compared with that before the firing. In association with this contraction, the gap-adjusting laminates (the spacers) for the plates for firing were contracted likewise, so that the gap between the green laminate and the upper plate for firing could be kept approximately constant before and after the firing.

In contrast, a laminate was made without any oxide green sheet for the purpose of comparison. The laminate fused with the upper and lower magnesia plates, warping and waving. This laminate was contracted by 20% while being fired, so that, when fusing with the magnesia plates, the contraction did not occur at and from the fused portion to cause warp and waviness in such a portion.

### Example 2

A piezoelectric ceramic sintered body of Example 2 of the present invention was made in the same manner as in Example 1, except that a ceramic green body on which a green sheet was laminated was formed in the same manner as in Example 1, and then that surface electrodes were formed on the surface of the ceramic green body with a silver palladium paste by the printing process.

That is, in Example 2, the oxide green sheet was so laminated as to cover the surface electrodes which were formed on the surface of the ceramic green body, and the green laminate was fired.

The piezoelectric ceramic sintered body of Example 2 thus made had high flatness as well as that of Example 1.

### Example 3

A piezoelectric ceramic sintered body of Example 3 of the present invention was made in the same manner as in Example 1, except that 10 cm square piezoelectric green sheets were prepared in the same manner as in Example 1, that different patterns of electrodes were formed on the piezoelectric green sheets, respectively, with a silver palladium paste by the printing process, and then that a predetermined number of the above piezoelectric green sheets are laminated and pressed under a pressure of 200 kg/cm² so as to make a ceramic green body with a thickness of 0.1 to 2.5 mm which contains the inner electrode layers therein.

The piezoelectric ceramic sintered body of Example 3 thus made had high flatness as well as that of Example 1.

### Example 4

A piezoelectric ceramic sintered body of Example 4 of the present invention was made in the same manner as in Examples 1, 2 and 3, except that a ceramic green body containing inner electrode layers was formed in the same manner as in Example 3, and that outer electrodes were formed on the surfaces of the ceramic green body in the same manner as in Example 2 so as to make the ceramic green body having the inner electrode layers and the surface electrode layers.

The piezoelectric ceramic sintered body of Example 4 thus made had high flatness as well as that of Example 1.

### Example 5

A piezoelectric ceramic sintered body of Example 5 of the present invention was made as follows.

First, a ceramic green body was formed in the same manner as in Examples 1 to 4.

Next, MgO, ethyl cellulose and α-terpineol were blended at a ratio of 1:0.06:0.5 and mixed in a three-roll mill to form an oxide paste.

Then, layers of this oxide paste were formed on both sides of the ceramic green body by the printing process.

The resultant green laminate was fired in the same manner as in Examples 1 to 4.

The piezoelectric ceramic sintered body of Example 5 thus made had high flatness as well as those of Examples 1 to 4.

Also, in Example 5, by using the oxide particles with a particle size of 2 μm or less, the ceramic sintered body had flat surfaces as in Examples 1 to 4, and it was particularly excellent.

### Example 6

A piezoelectric ceramic sintered body of Example 6 of the present invention was made as follows.

First, a green laminate was formed in the same manner as in Example 1.

Next, 5 sheets of the above green laminates were laminated and pressed under a pressure of 200 kg/cm² to make a green multi-ply consisting of the five green laminates.

Then, the green multi-ply was de-bound at 400° C. for 2 hours, and the green multi-ply consisting of the five green laminates was placed on a magnesia plate for firing as described in the part of the embodiments, and fired at 1,100° C. for 2 hours.

Finally, the sintered multi-ply thus obtained was dipped in ethanol at 40° C. for 24 hours. After that, the sintered multi-ply was divided at the oxide layers into five ceramic sintered bodies by using an ultrasonic vibrator.

The ceramic sintered bodies were made having a thickness of 0.1 to 2.5 mm after divided by the above procedure, and it was found that any of the ceramic sintered bodies with various thickness within the above range could be sintered without the fusion with the magnesia plate. Thus, the ceramic sintered bodies had few warp and high flatness and they could be efficiently produced.

In addition, by using the oxide particles with a particle size of 2 μm or less, the ceramic sintered body could have flat surfaces and they were particularly excellent.

In this Example, the piezoelectric ceramic green body was contracted by about 20% after the firing as compared with that before the firing.

By contrast to this, a laminate without any oxide green sheet laminated, which was made for comparison, fused with the upper and lower magnesia plates while being fired, and therefore had warp and waviness. Since this laminate was contracted by 20% while being fired, and fused with the magnesia plate, the contraction was prevented at and from the fused portion, so that the laminate warped and waved. In addition, the oxide was incorporated in the specimen after fired, so that the sinter could not be divided.

### Example 7

A piezoelectric ceramic sintered body of Example 7 of the present invention was made by preparing a multi-ply consisting of five green laminates in the same manner as in Example 6.

The green laminates were de-bound at 400° C. for 2 hours, and then, the green multi-ply consisting of the five green laminates was placed between each of the magnesia plates for firing which were stacked at given intervals, and fired at 1,100° C. for 2 hours, as described in the part of the embodiments.

In this regard, the spacers for the plates for firing were made in the same manner as in the above multi-ply, having a thickness 0.05 to 0.2 mm higher than that of the multi-ply. The spacers were disposed at the four corners to form a gap between each of the plates for firing. By doing so, there could be ensured a gap of 0.05 to 0.2 mm between the multi-ply and the upper plate for firing.

The sintered multi-ply was dipped in ethanol at a temperature of 40° C. for 24 hours, and it was then divided at its oxide layers into five ceramic sintered bodies.

Ceramic sintered bodies which had various thickness within a range of 0.1 to 2.5 mm after divided were made by the above procedure. As a result, it was found that any of the ceramic sintered bodies with a thickness within the above range did not fuse with the magnesia plate, and that it could be sintered having a warp within the determined gap (the gap between the green laminate and the upper plate for firing). Thus, the ceramic sintered bodies having few warp and high flatness could be efficiently produced.

In addition, by using the oxide particles with a particle size of 2 μm or less, particularly excellent ceramic sintered bodies having flat surfaces could be obtained.

In this Example, the piezoelectric ceramic green body was contracted by about 20% after fired as compared with the original size thereof before the firing. In association with the above contraction, the gap-adjusting laminates (the spacers) for the plates for firing were similarly contracted, so that the gap between the multi-ply and the upper plate for firing was kept substantially constant before and after the firing.

In contrast thereto, a green laminate was made without an oxide green sheet laminated thereon for the purpose of comparison, and the laminate fused with the upper and lower magnesia plates when fired, so that the resultant sinter had a warp and waviness. This laminate was contracted by 20% while being fired, so that, when it fused with the magnesia plates, the contraction was prevented at and from the fused portion. As a result, the sinter had a warp and waviness. Further, the oxide was incorporated in the specimen after fired, and therefore, the sinter could not be divided into individual sinters.

### Example 8

A piezoelectric ceramic sintered body of Example 8 of the present invention was made in the same manner as in Examples 6 and 7, except that a ceramic green body was made by laminating green sheets in the same manner as in Examples 6 and 7, and then that a surface electrode layer was formed on the surface of the ceramic green body with a silver palladium paste by the printing process.

That is, in Example 8, an oxide green sheet was laminated so as to cover the surface electrode layer which had been formed on the surface of the ceramic green body, and then, the laminate was fired.

The piezoelectric ceramic sintered body of Example 8 thus made could be divided at the oxide particle layers into individual ceramic sintered bodies, and they had high flatness as well as those obtained in Example 6.

### Example 9

A piezoelectric ceramic sintered body of Example 9 of the present invention was made in the same manner as in Examples 6 and 7, except that 10 cm square piezoelectric green sheets were prepared in the same manner as in Examples 6 and 2, then that different patterns of electrode layers were formed on the piezoelectric green sheets, respectively, with a silver palladium paste by the printing process and then that a predetermined number of such green sheets were laminated and pressed under a pressure of 200 kg/cm² so as to make a ceramic green body with a thickness of 0.1 to 2.5 mm, having inner electrode layers therein.

The piezoelectric ceramic sintered body of Example 9 thus made could be divided at the oxide particle layers into individual ceramic sintered bodies, and the ceramic sintered bodies had high flatness as well as those obtained in Example 6.

### Example 10

A piezoelectric ceramic sintered body of Example 10 of the present invention was made in the same manner as in Examples 6 to 9, except that a ceramic green body having inner electrode layers therein was made in the same manner as in Example 9, and then that outer electrode layers were formed on the surface of the ceramic green body in the same manner as in Example 7 so as to make the ceramic green body having the internal and surface electrode layers.

The piezoelectric ceramic sintered body of Example 10 thus made could be divided at the oxide particle layers into individual ceramic sintered bodies, and the ceramic sintered bodies had high flatness as well as those obtained in Example 6.

### Example 11

A piezoelectric ceramic sintered body of Example 11 of the present invention was made as follows.

First, a ceramic green body was made in the same manner as in Examples 6 to b 10.

Next, MgO particles, ethyl cellulose and α-terpineol were blended at a ratio of 1:0.06:0.5, and the mixture was kneaded in a three-roll mill to form an oxide paste.

Then, layers of the oxide paste were formed on both sides of the ceramic green body by the printing process.

Then, the green laminate was fired in the same manner as in Examples 6 to 10.

The piezoelectric ceramic sintered body of Example 11 thus made had high flatness as well as those obtained in Examples 5 and 6.

Also in Example 11, by using the oxide particles with a particle size of 2 μm or less, a particularly excellent ceramic sintered body could be obtained, which could be divided at the oxide particle layers into individual ceramic sintered bodies, having flat surfaces as well as those obtained in Examples 6 to 10.

### Example 12

A piezoelectric ceramic sintered body of Example 12 of the present invention was made in the same manner as in Examples 1, except that the nine through holes were formed in the green laminate by a punching machine.

The piezoelectric ceramic sintered body of Example 12 thus made had high flatness as well as those obtained in Examples 1.

### Example 13

A piezoelectric ceramic sintered body of Example 13 of the present invention was made in the same manner as in Examples 2, except that the nine through holes were formed in the green laminate by a punching machine.

The piezoelectric ceramic sintered body of Example 13 thus made had high flatness as well as those obtained in Examples 2.

### Example 14

A piezoelectric ceramic sintered body of Example 14 of the present invention was made in the same manner as in Examples 3, except that the nine through holes were formed in the green laminate by a punching machine.

The piezoelectric ceramic sintered body of Example 14 thus made had high flatness as well as those obtained in Examples 3.

### Example 15

A piezoelectric ceramic sintered body of Example 15 of the present invention was made in the same manner as in Examples 4, except that the nine through holes were formed in the green laminate by a punching machine.

The piezoelectric ceramic sintered body of Example 15 thus made had high flatness as well as those obtained in Examples 4.

### Example 16

A piezoelectric ceramic sintered body of Example 16 of the present invention was made in the same manner as in Examples 5, except that the nine through holes were formed in the green laminate by a punching machine.

The piezoelectric ceramic sintered body of Example 16 thus made had high flatness as well as those obtained in Examples 5.

What is claimed is

1. A flat ceramic sintered body fired at a predetermined firing temperature, wherein oxide particles having a melting point higher than the firing temperature are dispersively adhered to at least one of the main surfaces of said ceramic sintered body.

2. The ceramic sintered body according to claim 1, wherein said ceramic sintered body is a laminate having an inner electrode layer therein.

3. The ceramic sintered body according to claims 1 or 2, wherein a surface electrode layer is formed on the main surface of said ceramic sintered body.

4. The ceramic sintered body according to claim 3, wherein said oxide particles are dispersively on and adhered to at least the surface electrode layer.

5. The ceramic sintered body according to claim 1, further comprising through holes.

6. The ceramic sintered body according to claim 5, wherein the volume occupied by said through holes is within 20 of the total volume of the ceramic sintered body.

7. The ceramic sintered body according to claim 1, wherein the thickness of said ceramic sintered body is 500 μm or less.

8. The ceramic sintered body according to claim 1, wherein said ceramic sintered body is formed from a lead-based piezoelectric material.

9. The ceramic sintered body according to claim 1, wherein said oxide particles are of one, or two or more selected from the group consisting of magnesia (MgO), zirconia (ZrO₂) and alumina (Al₂O₃).

10. The ceramic sintered body according to claim 1, wherein the particle size of said oxide particles is 2 μm or less.

11. A method of producing a ceramic sintered body by firing a flat ceramic green body at a predetermined firing temperature, said method comprising the steps of
dispersing, in a resin, oxide particles having a melting point higher than the firing temperature to form a thinner sheet of the dispersion than the ceramic green body, thereby making an oxide green sheet,
laminating the oxide green sheet on the main surface of the ceramic green bodies as to make a green laminate in which an oxide particle-dispersed resin layer consisting of the oxide green sheet is formed on at least one of the main surfaces of the ceramic green body, and
placing the green laminate between each of plates for firing which are stacked at predetermined intervals, facing to each other, and firing the green laminate at the above predetermined firing temperature.

12. The method of producing a ceramic sintered body according to claim 11, further comprising the step of making the through holes in said green laminate between said laminating step and said firing step.

13. The method according to claim 11, further comprising the step of
making a green multi-ply by laminating a plurality of the green laminates,
firing the green multi-ply at the predetermined temperature in the step of firing to make a sintered multi-ply, and
dividing the sintered multi-ply at the oxide particle layers into individual ceramic sintered bodies.

14. A method of producing a ceramic sintered body by firing a flat ceramic green body at a predetermined firing temperature, said method comprising the steps of
forming an oxide particle-dispersed resin layer by printing, with a paste in which oxide particles having a melting temperature higher than the firing temperature are dispersed in a resin, on at least one of the main surfaces of the ceramic green bodies as to make a green laminate, and
placing the green laminate between each of plates for firing which are stacked at predetermined intervals, facing to each other, and firing the green laminate at the predetermined firing temperature.

15. The method of producing a ceramic sintered body according to claim 14, further comprising the step of making the through holes in said green laminate between said forming step and said firing step.

16. The method according to claim 14, further comprising the steps of
laminating a plurality of the green laminates to make a green multi-ply,
firing the green multi-ply at the predetermined temperature in the step of firing to make a sintered multi-ply, and
dividing the sintered multi-ply at the oxide particle layers into individual ceramic sintered bodies.

17. The method according to claims 11 or 14, wherein the thickness of said oxide particle-dispersed resin layer is 0.5 to 5 μm.

18. The method according to claims 11 or 14, further comprising the step of laminating ceramic green sheets to make a ceramic green body.

19. The method according to claim 18, further comprising the step of forming an electrode layer on said ceramic green sheet so that said ceramic green body contains the electrode layer therein.

20. The method according to claim 19, wherein an electrode layer is formed on the uppermost layer of the ceramic green body, and the oxide particle-dispersed resin layer is formed on the electrode layer in the step of making the ceramic green body.

21. The method according to claims 11 or 14, wherein said ceramic green body contains a lead-based piezoelectric material as a main component.

22. The method according to claims 11 or 14, wherein the particle size of said oxide particles is 2 μm or less.

23. The method according to claims 11 or 14, wherein said oxide particles are of one, or two or more selected from the group consisting of magnesia (MgO), zirconia (ZrO) and alumina (Al₂O₃).

24. The method according to claims 11 or 14, wherein the thickness of said oxide particle-dispersed resin layer is 5 μm or less.

25. The method according to claims 11 or 14, wherein the thickness of said ceramic sintered body is 500 μm or less.
